(19) United States
(12) Patent Application Publication
(10) Pub. No.: US 2008/0060026 A1
(43) Pub. Date: Mar. 6, 2008

(54) IPTV subscriber and security management

(75) Inventors: Michael Cheung, San Jose, CA (US); Mark Ammar Rayes, San Ramon, CA (US)

Correspondence Address: HICKMAN PALERMO TRUONG & BECKER, LLP, 2055 GATEWAY PLACE, SUITE 550, SAN JOSE, CA, 95110, US

(73) Assignee: CISCO TECHNOLOGY, INC.

(21) Appl. No.: 11/512,551

(22) Filed: Aug. 29, 2006

(51) Int. Cl. H04N 7/18; H04N 7/173

(52) U.S. Cl. 725/81; 725/112; 725/113; 725/80

(57) ABSTRACT

A method and apparatus is disclosed for security-management of IP TV subscribers across a network comprising: receiving and storing at an access network element, a plurality of requests to connect to one or more multicast groups from a plurality of ports; retrieving, the plurality of requests from the access network element; generating, from the plurality of requests a first profile associated with a first port, wherein the profile includes multicast group request information associated with the first port; and detecting one or more anomalies based on the first profile and subscriber information and generating a notification if one or more anomalies are detected.

### FIELD OF THE INVENTION

The present invention generally relates to IP television. The invention relates more specifically to providing IPTV subscriber security through network management.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

IP TV is digital television technology that utilizes the Internet Protocol over high-speed access, such as DSL and Metro Ethernet/Fiber, to provide television service to subscribers. Often IP TV is offered in conjunction with Video on Demand and may also include Internet and phone services. IP TV is an important element in the “triple play” (data, voice, and video) and “quadruple play” (data, voice, video, and mobility) service offerings. In the past, this technology has been nearly impossible with slow dial-up download speeds inhibiting any form of video content to be received. Now, however, as broadband is becoming more and more available to households worldwide, IP TV is expected to grow increasingly in the coming years.

In traditional cable television broadcast, the broadcast signals of all channels are accessible from the cable jack. Viewing a channel is controlled by filters at the customer premise. Once a channel signal is descrambled, it can be viewed on the TV. Channel spoofing/misappropriation is done to gain access to signals not subscribed to or purchased. Detecting channel spoofing is difficult because one would need to detect the frequency of the channel that a user is currently tuned into. The detection needs to be performed physically in the proximity of the user location due to the limited reach of the frequency detection device. Illegal viewers can only be detected if during the time of frequency detection, they are watching a channel that they have not purchased.

Unlike traditional television, with IP TV the packets of all channels are accessible and filtered at an access network element instead of at the customer premise. An access network element is a network switch for controlling and configuring a plurality of user ports; each port in the access network element maps to an IP TV customer. Multicast technology is used for delivery of content of different TV channels (referred to as a channel hereafter) to the end user in a bandwidth efficient manner. Each user port within the access network element is configured to a particular multicast group membership.

To spoof/misappropriate IP TV channels, one can change the configuration on the access network element, e.g. re-configure the multicast group membership. In many cases, service providers install the access network elements in places accessible to users, like the basement of an apartment building. Malicious users can gain access to the access network elements with relative ease and reconfigure the access network element to forward a channel to which the users do not subscribe. Thus, there is a clear need for detecting and preventing IP TV channel misappropriation, that is, access by users to channels to which they do not subscribe.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a typical IP TV implementation upon which one embodiment may be implemented.

FIG. 2 is a block diagram that illustrates an overview of an operational context in which an embodiment may be implemented.

FIG. 3 is a block diagram that illustrates a computer system upon which an embodiment may be implemented.

### DETAILED DESCRIPTION

A method for providing security-management over IPTV subscribers across a network is disclosed. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 Structural and Functional Overview
2.0 Implementation Mechanisms-Hardware Overview
3.0 Extensions and Alternatives

### 1.0 Structural and Functional Overview

In the area of IP TV subscriber and security management, a mechanism is described for detecting when an access network element is forwarding IP TV channel traffic to a user port of a user not entitled to the channel.

In IP TV, each channel corresponds to a multicast group with an associated multicast address. IP multicasting is defined as the transmission of an IP datagram to a “multicast group”. A multicast datagram is delivered to all members of its destination multicast group. The membership of a multicast group is dynamic; that is, a multicast group member may join and leave groups at any time.

In a typical IP TV implementation, an end user selects a channel to watch through a set-top-box, also referred to as a home access gateway. In response, the set-top-box generates a request for joining the multicast group for the channel. The request is sent to the access network element. Typically, the port of each user in the access network element is configured according to the user channel subscription. In other words, each user port is configured to belong to the multicast groups of the channels to which the user subscribes. The channel selection menu displayed through the set-top-box may be built according to the multicast memberships of the user port. When a multicast join request is received at the user port, if it is a member of the requested multicast group, the access network element accepts the request and forwards packets for the channel to the set-top-box. Internet Group Management Protocol (IGMP) (RFC-2236) may be used to control the multicast traffic and the joining/leaving of multicast groups.

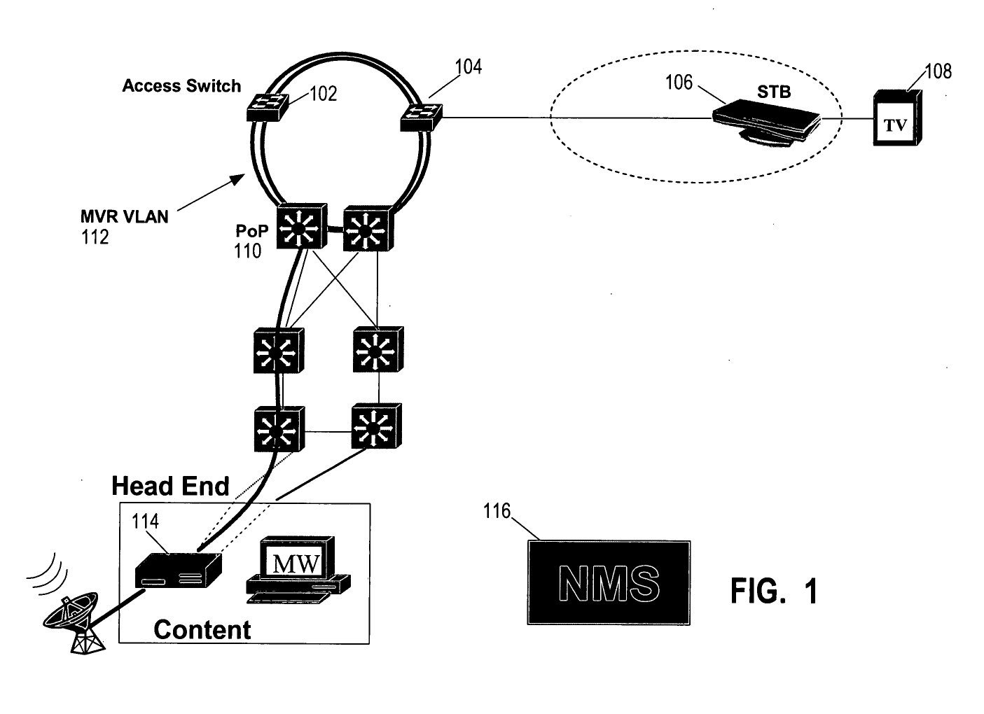

FIG. 1 illustrates a typical IP TV implementation. A selection by the user to watch a particular channel on the television 108 is sent to a set-top-box (STB) 106. The STB 106 generates a request to join the multicast session with a multicast address corresponding to the selected channel. The access switch 104 or 102 validates the request against the port configuration and joins the requested channel from the Multicast Virtual Local Area Network Registration (MVR) Virtual Local Area Network (VLAN) 112.

The content is distributed from the content end 114 to the point-of-presence (PoP) 110 via IP multicast. A PoP is an access point from one place to the rest of the Internet. A PoP has a unique Internet Protocol (IP) address. Internet service provider (ISP) or an online service provider has a point-of-presence on the Internet and in most cases more than one.

MVR VLAN 112 is a special VLAN set up in the ring. It allows a single multicast VLAN to be shared and accessible by all access switches in the ring. According to one aspect of the invention, multicast channels are statically joined at and mapped to the MVR VLAN 112. The MVR VLAN 112 is accessible by all ports on the rings.

An embodiment for IPTV security consists of two components 1) Port access-request profile establishment, and 2) Port access-request profile verification. Under port access-request profile establishment, an access network element logs data that tracks the channel request activity of the ports. A Network Management System (NMS) collects and stores the information logged at the access network elements. The NMS monitors, controls and maintains the IP TV system. Under port access-request profile verification, the information collected by the NMS is used to detect unauthorized access to channels.

### Requesting Channels

The set-top-box is connected to the users TV and the access network element and sends requests for particular channels to the access network element. The access network element is connected to the multicast broadcast on the Virtual Local Access Network. An access network element such as Cisco's Catalyst 3750 can be used.

When a request for a particular channel is generated at the set-top-box and sent to the access network element, the request is processed at the access network element to determine if the user port (e.g., port 5 of the Catalyst 3750) is a member of the respective multicast group. If the access network element accepts the request, the access network element starts forwarding the associated packets to the user port. However, if the user port is not a member of the multicast group, the access network element will reject the request and will not forward the channel packets to that particular port.

### Port Access-Request Profile Establishment

The access network element maintains a port request-activity log, which tracks user request activity on a port basis. In an embodiment, the port request-activity log records request acceptances and rejections on a per port per multicast group basis.

The NMS retrieves data from port request-activity logs at the access network elements. After retrieving data from the port request-activity logs, the port request-activity logs may be purged. The NMS consolidates the data retrieved within a port request-activity profile, which also tracks the request activity on a port per multicast group basis. According to one aspect, the port request-activity profile can be generated by extending IGMP-MIB described in RFC-2933 to keep a log of the activities on a per user port per multicast group.

### Port Access-Request Profile Establishment

In an embodiment of the present invention, the NMS uses information from a port request-activity profile to generate information about channel access by users. By correlating the user port to the subscriber and multicast address to the channels, a user channel-activity profile may be generated that shows the amount of access to channels by users. The NMS can retrieve the subscriber information from a customer database and compare the information against the user channel-activity log to detect anomalies, such as discrepancies between channel requests accepted and channels subscribed to.

For example, if the user channel profile indicated that channel A (with multicast address a.b.c.d) is being accepted by the access network element while the user is not subscribing to it, it will indicate that the user is watching an unsubscribed channel illegally. It is likely that the network is being hacked into. The network administration can then take the appropriate corrective actions.

Any anomalies detected may be reported to the network administrator. The verification can be done on a periodic basis, for example, once a month.

In another embodiment of the present invention, the user channel-activity profile can be used for subscriber classification for marketing. In this aspect, the amount of access to each channel contained in the user channel profile is used to market new channels or products to the subscriber. For example, a new soccer channel can be targeted to subscribers that access to sports channels frequently.

### Retrieving and Purging the Port Request-Activity Log

Preferably, the NMS retrieves and purges data from port request-activity logs often enough to avoid running out of memory and/or storage for the logs. The access network element needs to have enough memory to store enough log entries without losing any data between accesses by the NMS.

According to an embodiment, a notification protocol such as Simple Network Management Protocol (SNMP) can be used by the access network element to generate and send notification to the NMS to retrieve and purge date from the port request-activity logs. A threshold based notification system may be used. In this embodiment, a notification is sent when the amount of memory in a buffer used to store the port request-activity log reaches a threshold. For example, the notification is sent to the NMS once the buffer has reached a particular threshold such as 80%, notifying the NMS that it should purge the log and retrieve the information in the buffer.

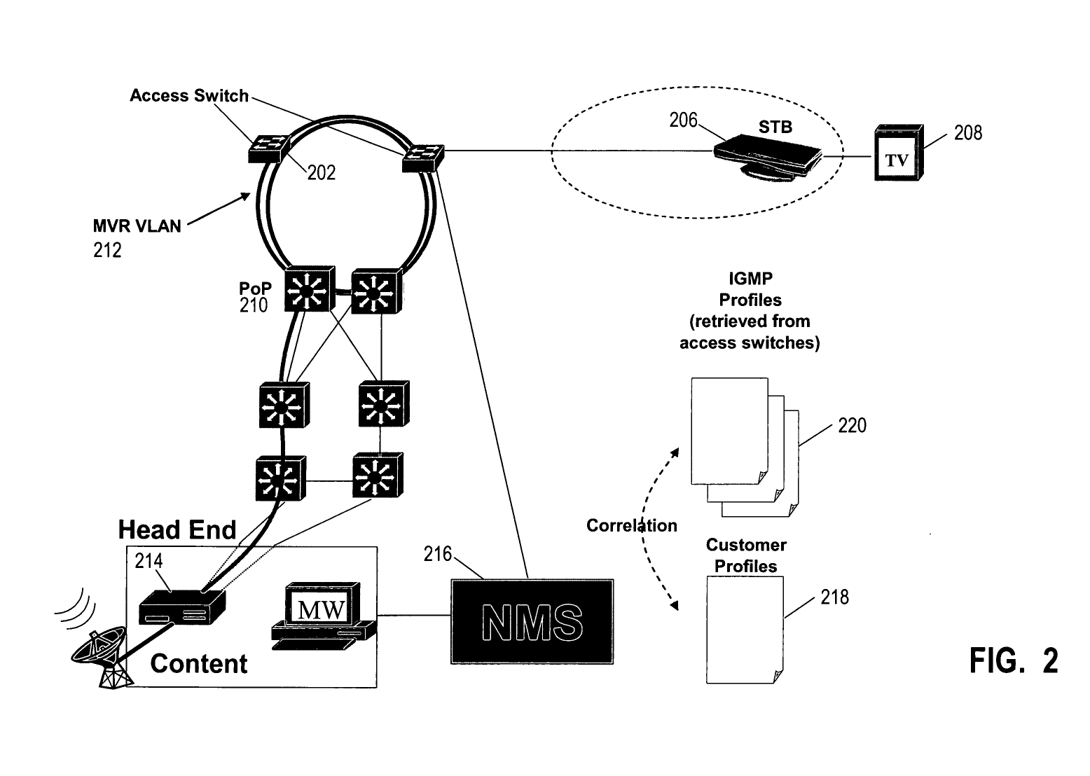

FIG. 2 illustrates an operational context in which one embodiment of this invention may be implemented. The content is distributed from the content end 214 to a point-of-presence (PoP) 210 via an IP multicast. A MVR VLAN 212 is set up in the ring. Multicast channels are statically joined at and mapped to the MVR VLAN 212. The MVR VLAN 212 is accessible by all ports on the rings.

A selection by the user to watch a particular channel is sent to a set-top-box (STB) 206. The STB generates a request to join the multicast session with multicast address corresponding to the selected channel. Access switches 204 or 202 validate the request against the port configuration and join the requested channel from the MVR VLAN 212. The Access switches also log all requests against the port configuration and join the requested channel from the MVR VLAN 212. A Network Management System (NMS) 216 collects all request activities at all access network elements 202 and 204 and builds a Port access-request profile per user port 220. The NMS then perform a determination to detect any abnormalities based on Port access-request profiles and customer profiles 218 maintained in the NMS.

### 2.0 Implementation Mechanisms—Hardware Overview

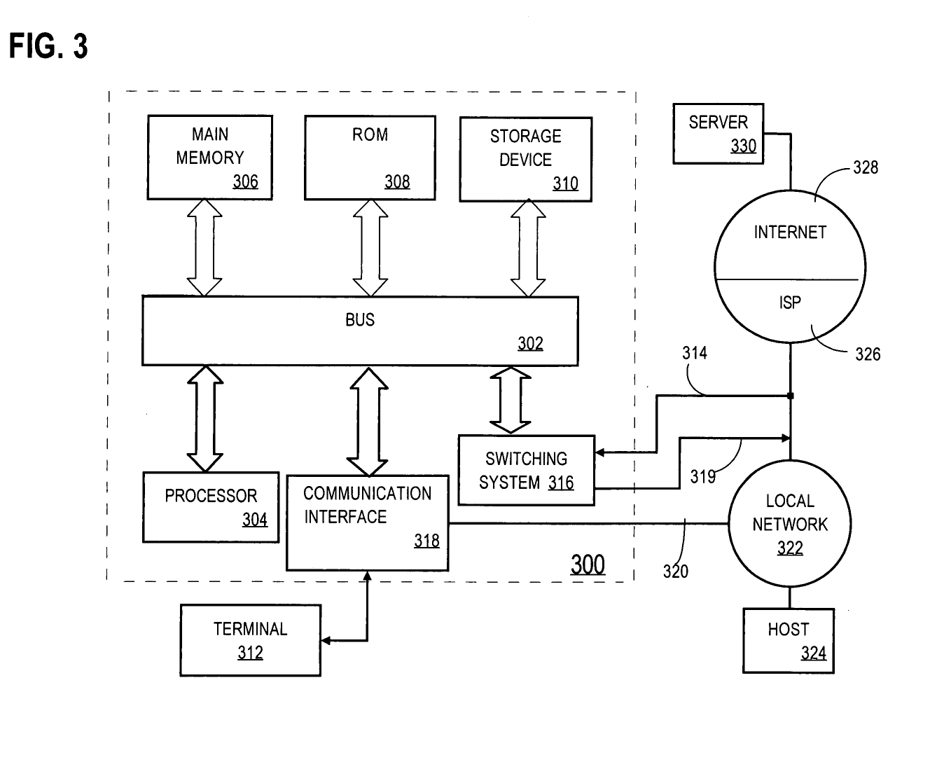

FIG. 3 is a block diagram that illustrates a computer system 300 upon which an embodiment of the invention may be implemented. The preferred embodiment is implemented using one or more computer programs running on a network element such as a router device. Thus, in this embodiment, the computer system 300 is a router.

Computer system 300 includes a bus 302 or other communication mechanism for communicating information, and a processor 304 coupled with bus 302 for processing information. Computer system 300 also includes a main memory 306, such as a random access memory (RAM), flash memory, or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, flash memory, or optical disk, is provided and coupled to bus 302 for storing information and instructions.

A communication interface 318 may be coupled to bus 302 for communicating information and command selections to processor 304. Interface 318 is a conventional serial interface such as an RS-232 or RS-422 interface. An external terminal 312 or other computer system connects to the computer system 300 and provides commands to it using the interface 314. Firmware or software running in the computer system 300 provides a terminal interface or character-based command interface so that external commands can be given to the computer system.

A switching system 316 is coupled to bus 302 and has an input interface 314 and an output interface 319 to one or more external network elements. The external network elements may include a local network 322 coupled to one or more hosts 324, or a global network such as Internet 328 having one or more servers 330. The switching system 316 switches information traffic arriving on input interface 314 to output interface 319 according to pre-determined protocols and conventions that are well known. For example, switching system 316, in cooperation with processor 304, can determine a destination of a packet of data arriving on input interface 314 and send it to the correct destination using output interface 319. The destinations may include host 324, server 330, other end stations, or other routing and switching devices in local network 322 or Internet 328.

The invention is related to the use of computer system 300 for graceful restart in a multi-process operating system. According to one embodiment of the invention, the techniques for graceful restart are provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire, and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Communication interface 318 also provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic, or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic, or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320, and communication interface 318. In the Internet example, a server 330 might transmit a requested code for an application program through Internet 328, ISP 326, local network 322, and communication interface 318. In accordance with the invention, one such downloaded application provides for graceful restart in a multi-process operating system as described herein.

Processor 304 may execute the received code as it is received, and/or stored in storage device 310, or other non-volatile storage for later execution. In this manner, computer system 300 may obtain application code in the form of a carrier wave.

### 3.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A system for IP TV security, comprising:
an access network element comprising one or more user ports, wherein each of said one or more user ports are connected to a home access gateway of a user, wherein said access network element forwards TV channel network traffic via said one or more user ports to a respective home access gateway;
said access network element being configured to generate a log that tracks channel request activity associated with each user port of said one or more user ports;
a network management system that is connected to said access network element via a network;
wherein said network management system is configured to:
obtain data from said log at said access network element;
based on said data obtained from said log, generate channel access information indicating channel access by a user; and
use said channel access information to determine presence of channel misappropriation.

2. A system as recited in claim 1, wherein said network management system is configured to obtain data from said log at said access network element at a periodic time interval.

3. A system as recited in claim 1, wherein said network management system is configured to obtain data from said log at said access network element in response to a notification issued by the access network element.

4. A system as recited in claim 3, wherein said access network element is configured to send said notification when said log holds a threshold amount of data.

5. A system as recited in claim 1, wherein said log tracks channel request activity by user port and multicast group.

6. A system as recited in claim 5, wherein said network management system is configured, to generate said channel access information, to correlate a user port of said one or more user ports to a user and a multicast group to a TV channel.

7. A system as recited in claim 6, wherein said network management system is configured to compare said channel access information to subscriber information to detect access by a certain user to a certain channel to which said certain user does not subscribe.

8. A system as recited in claim 1, wherein the access network element forwards TV channel network traffic via said one or more user ports to a respective home access gateway by way of internet group management protocol.

9. A method for management of IP TV subscriber across a network comprising:
obtaining data from a log via said network, wherein the log tracks TV channel request activity associated with a plurality of requests from a plurality of user ports to connect to one or more multicast groups;
generating, based on the data from the log, a profile that describes channel request activity associated with requests to connect to one or more multicast groups from the plurality of user ports; and
based on the first profile and subscriber information, determining whether a user associated with a user port of said plurality of user ports accessed a certain TV channel to which said user did not subscribe.

10. A method as recited in claim 9, wherein obtaining data from a log is performed at a periodic time interval.

11. A method as recited in claim 9, wherein obtaining data from a log is performed in response to a notification issued by an access network element that holds the log.

12. A method as recited in claim 11, wherein the steps further include generating, based on the profile and the subscriber information, certain data that correlates users to user ports and channels to multicast groups.

13. A method as recited in claim 12, wherein the steps further include comparing said certain data to the subscriber information to determine whether a certain user accessed a certain channel to which said certain user does not subscribe.

14. An apparatus, for management of IP TV across a network comprising:
a network interface for coupling to a data network for receiving one or more packet flows there from;
one or more processors;
one or more user ports, wherein each of said one or more user ports are connectable to a home access gateway, wherein said apparatus is configured to forward TV channel network traffic via said one or more user ports to a respective home access gateway; and
wherein said apparatus is configured to generate a port-request activity log that tracks channel request activity associated with a plurality of requests to connect to one or more multicast groups from said one or more user ports.

15. An apparatus as recited in claim 14, wherein said apparatus is further configured to transmit a notification via said data network to retrieve data from said log.

16. An apparatus as recited in claim 14, wherein said apparatus is configured to send said notification when said log holds a threshold amount of data.

17. An apparatus as recited in claim 14, wherein said apparatus forwards TV channel network traffic via said one or more user ports to a respective home access gateway by way of internet group management protocol.

18. An apparatus, for management of IP TV across a network comprising:
means for coupling to a data network for receiving one or more packet flows there from;
means for forwarding TV channel network traffic via one or more user ports to a respective home access gateway; and
means for generating a port-request activity log that tracks channel request activity associated with a plurality of requests to connect to one or more multicast groups from said one or more user ports.

19. An apparatus as recited in claim 18, further comprising means for transmitting a notification via said data network to retrieve data from said log.

20. An apparatus as recited in claim 18, wherein said apparatus further comprises means for sending said notification when said log holds a threshold amount of data.

21. An apparatus as recited in claim 18, further comprising means for forwarding TV channel network traffic via said one or more user ports to a respective home access gateway by way of internet group management protocol.
